(19) United States
(12) Patent Application Publication
(10) Pub. No.: US 2012/0021754 A1
(43) Pub. Date: Jan. 26, 2012

(54) RADIO COMMUNICATION DEVICE AND BANDWIDTH DETERMINATION METHOD

(75) Inventors: Yoshihiko Ogawa, Kanagawa (JP); Sergio Nakao, Kanagawa (JP); Daichi Imamura, Kanagawa (JP); Katsuhiko Hiramatsu, Kanagawa (JP); Kenichi Miyoshi, Kanagawa (JP); Megumi Ichikawa, Kanagawa (JP); Sadaki Futagi, Ishikawa (JP); Yasuaki Yuda, Kanagawa (JP); Ayako Horiuchi, Kanagawa (JP)

(73) Assignee: Panasonic Corporation, Kadoma-shi, OSAKA (JP)

(21) Appl. No.: 13/062,177

(22) PCT Filed: Sep. 3, 2009
(86) PCT No.: PCT/JP2009/004358

§ 371 Date: Aug. 9, 2011

(30) Foreign Application Priority Data
Sep. 4, 2008 (JP) 2008-227501

(51) Int. Cl. H04W 72/04

(52) U.S. Cl. 455/450

(57) ABSTRACT

Disclosed is a radio communication device that, even when a terminal erroneously receives a retransmission grant or a response signal from a base station, can reduce the number of other terminals in which the terminal interferes at a retransmission. In this device, a determination unit (205) determines a bandwidth between the two ends of a transmission band allocated to a transmitted signal at the retransmission of the transmitted signal. An allocation unit (209) allocates the transmitted signal to a frequency resource based on the bandwidth that is input from the determination unit (205). The determination unit (205) increases at the retransmission the amount of decrease in the bandwidth from the previous transmission, as the consecutiveness of the transmitted signal in the frequency region decreases.

### TECHNICAL FIELD

The present invention relates to a radio communication apparatus and a bandwidth determining method.

### BACKGROUND ART

With 3GPP LTE (3rd Generation Partnership Project Long-Term Evolution) or LTE-Advanced, which is developed LTE, studies are underway to use both localized transmission and distributed transmission in the uplink. That is, both localized transmission and distributed transmission are used in communication between each radio communication terminal apparatus (hereinafter “terminal”) and a radio communication base station apparatus (hereinafter “base station”).

In addition, with LTE, HARQ (Hybrid Automatic Repeat reQuest) is applied to transmission data (uplink data) transmitted from each terminal to a base station in the uplink. With HARQ, a base station performs CRC (cyclic redundancy check) check on uplink data, and, when the result is CRC=OK (no error), feeds an ACK (acknowledgement) signal back to a terminal as a response signal, and, on the other hand, when the result is CRC=NG (error present), feeds a NACK (negative acknowledgment) signal to the terminal, as a response signal. Upon receiving a NACK signal as a response signal, a terminal retransmits uplink data (retransmission data) to a base station.

Here, as HARQ applied to uplink data, two HARQ techniques (hereinafter, referred to as “first HARQ” and “second HARQ”) are being studied (see Non-Patent Literatures 1 and 2).

With the first HARQ, a base station transmits resource allocation information (hereinafter “grant”) about uplink data (the first transmission data), to each terminal at the time of the first transmission. In addition, a base station feeds a response signal back to each terminal every time the base station receives uplink data from each terminal. Meanwhile, at the time of the first transmission, each terminal allocates uplink data to frequency resources indicated by the received grant, and, at the time of retransmission, allocates uplink data to frequency resources determined based on the frequency resources indicated by the grant received at the time of the first transmission and predetermined rules, and transmits the uplink data to a base station. As described above, with the first HARQ, grant is reported to each terminal only at the time of the first transmission, so that it is possible to reduce the amount of signaling required to report resource allocation. Here, frequency resources used at the time of retransmission are determined in advance according to rules, and each terminal cannot select frequency resources each time of retransmission, so that the reception quality of frequency resources is not always good at the time of retransmission.

With the second HARQ, a base station transmits grant to each terminal at the time of the first transmission. Moreover, when there is an error (CRC=NG) in uplink data and a NACK signal is fed back to a terminal as a response signal, a base station transmits retransmission grant indicating resource allocation for uplink data (retransmission data), to the terminal. Meanwhile, a terminal allocates uplink data to frequency resources indicated by grant or retransmission grant from a base station, and transmits the uplink data to the base station. As described above, with the second HARQ, each terminal uses retransmission grant reported every time uplink data is retransmitted, so that it is possible to allocate uplink data to frequency resources allowing reception quality to be good at the time of retransmission. Here, retransmission grant is reported from a base station to each terminal each time of retransmission, so that the amount of signaling required to report resource allocation increases.

Therefore, studies are underway to combine the first HARQ and the second HARQ in order to improve the reception quality of uplink data at the time of retransmission while preventing an increase in the amount of signaling of resource allocation information (grant and retransmission grant) (for example, see Non-Patent Literature 2). To be more specific, a base station applies one of the first HARQ and the second HARQ, depending on, for example, variations in propagation path quality between the base station and a terminal. Then, when receiving only a NACK signal at the timing to receive a response signal, a terminal retransmits uplink data using frequency resources determined based on the frequency resources reported by grant at the time of the first transmission, and predetermined rules, by applying the first HARQ. On the other hand, when receiving a NACK signal and retransmission grant at the timing to receive a response signal, a terminal retransmits uplink data using frequency resources reported by the retransmission grant, by applying the second HARQ. That is, a terminal determines HARQ to be applied to uplink data (retransmission data), based on whether or not to receive retransmission grant.

### CITATION LIST

### Non-Patent Literature

[NPL 1] R1-070244, “Modifications of Downlink Asynchronous HARQ scheme”, 3GPP TSG RAN1 #47bis, Sorrento, Italy, Jan. 15-19, 2007
[NPL 2] R1-070245, “Modifications of Uplink Synchronous HARQ scheme”, 3GPP TSG RAN1 #47bis, Sorrento, Italy, Jan. 15-19, 2007

### SUMMARY OF INVENTION

### Technical Problem

With the above-described prior art, when a base station transmits retransmission grant to a terminal that retransmits uplink data (hereinafter referred to as “retransmitting terminal”) (when the second HARQ is applied to uplink data), and at the same time, the base station can allocate other terminals to frequency resources determined based on frequency resources scheduled to be used for transmission from a retransmitting terminal using the first HARQ, that is, the frequency resources reported by grant at the time of the first transmission, and predetermined rules. That is, a base station allocates new frequency resources to uplink data (retransmission data) from a retransmitting terminal using retransmission grant, and allocates the frequency resources used by the retransmitting terminal to uplink data (the first transmission data) from other terminals using grant.

However, a case is possible where, although a base station transmits retransmission grant to a retransmitting terminal, the retransmitting terminal cannot detect the retransmission grant directed to the retransmitting terminal (that is, the retransmitting terminal detects only a NACK signal). In this case, the retransmitting terminal correctly receives only a NACK signal, and therefore, determines that the first HARQ is applied to uplink data from the retransmitting terminal. Therefore, a retransmitting terminal allocates uplink data (retransmission data) to frequency resources determined based on the frequency resources used at the time of the first transmission, and based on predetermined rules.

As a result of this, collisions occur between uplink data (retransmission data) from a retransmitting terminal and uplink data (the first transmission data) from other terminals, in frequency resources determined based on the frequency resources used by the retransmitting terminal at the time of the first transmission and predetermined rules. That is, uplink data (retransmission data) from a retransmitting terminal interferes with uplink data (the first transmission data) from other terminals. In this way, uplink data (retransmission data) from a retransmitting terminal interferes with uplink data (the first transmission data) from other terminals, so that the reception quality of uplink data (the first transmission data) from other terminals deteriorates in a base station, and CRC check is highly likely to be NG (error present). In particular, when a retransmitting terminal transmits uplink data (retransmission data) by distributed transmission, uplink data (retransmission data) is allocated to discontinuous frequency resources (transmission bands) distributed over a wide area, so that the retransmitting terminal is more likely to interfere with more other terminals.

In addition, when correctly receiving uplink data from a terminal, a base station can transmit an ACK signal to that terminal, and, at the same time, allocate retransmission resources scheduled to be used by that terminal, to uplink data from other terminals. However, when a terminal detects an ACK signal as a NACK signal by mistake, the terminal allocates uplink data (retransmission data) to frequency resources for retransmission. As a result of this, when a terminal detects an ACK signal as a NACK signal by mistake, collisions occur between uplink data (retransmission data) from a retransmitting terminal and uplink data (the first transmission data) from other terminals, in frequency resources for retransmission from the retransmitting terminal. That is, uplink data (retransmission data) from a retransmitting terminal interferes with uplink data (the first transmission data) from other terminals.

It is therefore an object of the present invention to provide a radio communication apparatus and a bandwidth determining method to reduce the number of other terminals to be interfered with from a terminal at the time of retransmission even if the terminal fails to receive correctly retransmission grant or a response signal from a base station.

### Solution to Problem

The radio communication apparatus according to the present invention adopts a configuration to includes: a determination section that determines a bandwidth from an end to the other end of a transmission band to allocate transmission signals at a time to retransmit the transmission signals; and an allocating section that allocates the transmission signals to frequency resources, based on the bandwidth, wherein, when a degree of continuity of the transmission signals in a frequency domain at a time of a last transmission is lower, the determination section increases an amount of decrease in the bandwidth at a time of retransmission, with respect to the time of last transmission.

The bandwidth determining method according to the present invention to determine a bandwidth from an end to the other end of a transmission band to allocate transmission signals at the time to retransmit the transmission signals, wherein, when a degree of continuity of the transmission signals in a frequency domain at a time of a last transmission is lower, an amount of decrease in the bandwidth at a time of retransmission increases with respect to the time of last transmission.

### Advantageous Effects of Invention

According to the present invention, even if a terminal fails to receive correctly retransmission grant or a response signal from a base station by mistake, it is possible to reduce the number of other terminals, which are interfered with from the terminal at the time of retransmission.

### BRIEF DESCRIPTION OF DRAWINGS

FIG. 1A shows bands to transmit signals transmitted at the time of localized transmission according to Embodiment 1 of the present invention;

FIG. 1B shows bands to transmit signals transmitted at the time of distributed transmission according to Embodiment 1 of the present invention;

FIG. 2 is a block diagram showing a configuration of a base station according to Embodiment 1 of the present invention;

FIG. 3 is a block diagram showing a configuration of a terminal according to Embodiment 1 of the present invention;

FIG. 4 shows processing to determine bandwidths of transmitted signals according to Embodiment 1 of the present invention;

FIG. 5 shows sequences according to Embodiment 1 of the present invention;

FIG. 6 shows association between the degree of continuity at the time of last transmission and the degree of continuity at the time of retransmission according to Embodiment 1 of the present invention (determination example 1-1);

FIG. 7 shows association between the degree of continuity at the time of last transmission and the degree of continuity at the time of retransmission according to Embodiment 1 of the present invention (determination example 1-2);

FIG. 8A shows association between the degree of continuity at the time of last transmission and the degree of continuity at the time of retransmission according to Embodiment 1 of the present invention (determination example 1-3);

FIG. 8B shows association between the degree of continuity at the time of last transmission and the degree of continuity at the time of retransmission according to Embodiment 1 of the present invention (determination example 1-3);

FIG. 9 shows association between the degree of continuity at the time of last transmission and the degree of continuity at the time of retransmission according to Embodiment 1 of the present invention (determination example 1-4);

FIG. 10 shows another example of association between the degree of continuity at the time of last transmission and the degree of continuity at the time of retransmission according to Embodiment 1 of the present invention;

FIG. 11 shows another example of association between the degree of continuity at the time of last transmission and the degree of continuity at the time of retransmission according to Embodiment 1 of the present invention;

FIG. 12 shows another processing to determine bandwidths of transmission signals according to Embodiment 1 of the present invention;

FIG. 13 shows another processing to determine bandwidths of transmission signals according to Embodiment 1 of the present invention;

FIG. 14 shows association between the degree of continuity and the amount of decrease in bandwidths;

FIG. 15A shows processing to determine bandwidths of transmission signals according to Embodiment 2 of the present invention;

FIG. 15B shows processing to determine bandwidths of transmission signals according to Embodiment 2 of the present invention;

FIG. 16A shows processing to determine bandwidths of transmission signals according to Embodiment 3 of the present invention;

FIG. 16B shows processing to determine bandwidths of transmission signals according to Embodiment 3 of the present invention;

FIG. 17A shows processing to determine bandwidths of transmission signals according to Embodiment 4 of the present invention; and

FIG. 17B shows processing to determine bandwidths of transmission signals according to Embodiment 4 of the present invention.

### DESCRIPTION OF EMBODIMENTS

Now, embodiments of the present invention will be described in detail with reference to the accompanying drawings

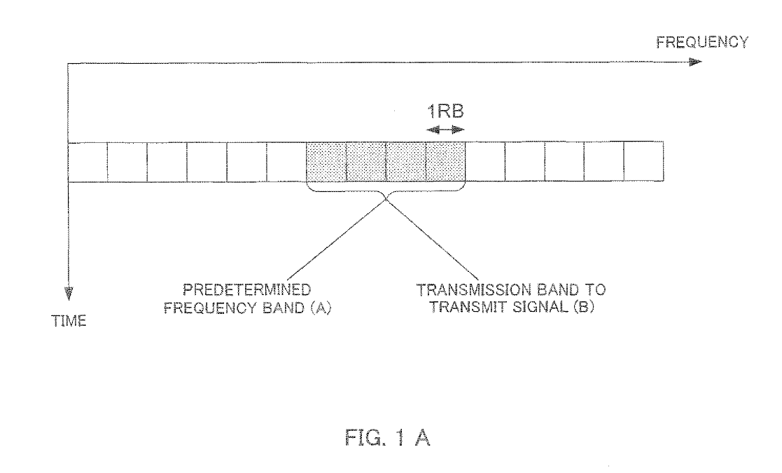

In the following descriptions, a transmission method to transmit signals in a plurality of transmission bands (frequency resources) allocated to one terminal such that the plurality of transmission bands all continue in the frequency domain, is “localized transmission.” For example, as shown in FIG. 1A, with localized transmission, transmission signals (uplink data) from one terminal are allocated to four consecutive resource blocks (RBs). On the other hand, a transmission method to transmit signals in a plurality of transmission bands allocated to one terminal such that at least one of the plurality of transmission bands does not continue, is “distributed transmission.” For example, as shown in FIG. 1B, with distributed transmission, transmission signals from one terminal are allocated to four discontinuous RBs at intervals of three RBs.

Here, terminals supporting LTE may use localized transmission as shown in FIG. 1A, and, on the other hand, terminals supporting LTE-Advanced may use distributed transmission as shown in FIG. 1B, in addition to localized transmission shown in FIG. 1A. With LTE-Advanced, studies are underway to accommodate not only terminals supporting LTE-Advanced but also terminals supporting LTE. That is, with LTE-advanced, a case is possible where terminals supporting LTE and terminals supporting LTE-Advanced exist together in one frequency band. That is, with LTE-Advanced, although localized transmission is used both in terminals supporting LTE and terminals supporting LTE-Advanced, distributed transmission is used only in terminals supporting LTE-Advanced. Therefore, with LTE-Advanced, the number of terminals using distributed transmission is greater than the number of terminals using localized transmission.

Therefore, when a terminal cannot detect retransmission grant from a base station, it is preferable to take into account terminals using localized transmission, as other terminals likely to be interfered with from that terminal. Therefore, in the following descriptions, when a base station transmits retransmission grant to a terminal, assume that another terminal allocated to the frequency resources used by the terminal at the time of last transmission is a terminal using localized transmission.

In addition, a case in which a terminal using distributed transmission cannot detect retransmission grant from a base station interferes with more other terminals at the time of retransmission more than a case in which a terminal using localized transmission cannot detect retransmission grant from a base station. For example, as shown in FIG. 1A, transmission signals from a terminal using localized transmission are allocated to four consecutive RBs. In this case, as shown in FIG. 1A, as transmission bands other than the transmission band (four RBs) to which transmission signals are allocated, a transmission band composed of six consecutive RBs and a transmission band composed of five consecutive RBs are secured before and after the transmission band for the transmission signals, respectively. Here, assume that the base station transmits retransmission grant to a terminal using localized transmission, and newly allocates transmission signals from a plurality of other terminals (for example, terminals using localized transmission), to frequency bands as shown in FIG. 1A. Here, when the terminal using localized transmission cannot retransmission grant from the base station, and, for example, retransmits signals (retransmission signals) using the transmission band (the same transmission band as at the time of last transmission), collisions occur between retransmission signals and transmission signals from other terminals in the transmission band (four RBs) shown in FIG. 1A. However, in transmission bands other than the transmission band for the terminal using localized transmission, consecutive transmission bands enough for localized transmission are secured, so that transmission signals from other terminals are not likely to collide with retransmission signals even if other terminals use localized transmission.

By contrast with this, as shown in FIG. 1B, transmission signals from a terminal using distributed transmission are allocated to four RBs distributed over all the frequency bands. In this case, as shown in FIG. 1B, only transmission bands each composed of maximum three consecutive RBs are secured, as transmission bands other than the transmission band (4 RBs) to which transmission signals are allocated. Here, assume that the base station transmits retransmission grant to a terminal using distributed transmission as described above, and allocates transmission signals from a plurality of other terminals (for example, terminals using localized transmission), to frequency bands shown in FIG. 1B. Here, when the terminal using distributed transmission cannot detect retransmission grant from the base station, and, for example, retransmits signals (retransmission signals) using the transmission band (the same transmission band as at the time of last transmission), transmission bands for the retransmission signals are distributed over all the frequency bands, so that part of retransmission signals is highly likely to collide with transmission signals from other terminals using localized transmission.

Therefore, the number of other terminals to be interfered with from retransmission signals when a terminal using distributed transmission cannot detect retransmission grant from the base station, is highly likely to be greater than the number of other terminals to be interfered with from retransmission signals when a terminal using localized transmission cannot detect retransmission grant from the base station. In addition, when the degree of continuity of transmission bands to allocate transmission signals to is lower, that is, each interval between transmission bands to allocate transmission signals to is longer, retransmission signals from the terminal that could not have detected retransmission grant transmitted from a base station are more likely to collide with transmission signals from other terminals. As a result of this, the number of other terminals whose signal quality received in a base station deteriorates, increases. In other words, the degree of continuity of transmission bands to allocate transmission signals to (that is, the degree of continuity of transmission signals in the frequency domain), is lower, the number of terminals whose signal quality received in a base station deteriorates, increases.

Therefore, according to the present invention, the bandwidth from one end to the other end of a transmission band to allocate transmission signals to at the time of retransmission is determined, according to the degree of continuity of signals transmitted last time in the frequency domain. In addition, in the following descriptions, assume that a band having a bandwidth from one end to the other end of a transmission band to allocate transmission signals to, is a predetermined frequency band.

### Embodiment 1

With the present embodiment, the proportion of a band to transmit signals to a predetermined frequency band is used as the degree of continuity of transmission signals in the frequency domain, and, when that proportion is lower, the amount of decrease in the bandwidth of a predetermine frequency band at the time of retransmission increases with respect to the time of the last retransmission.

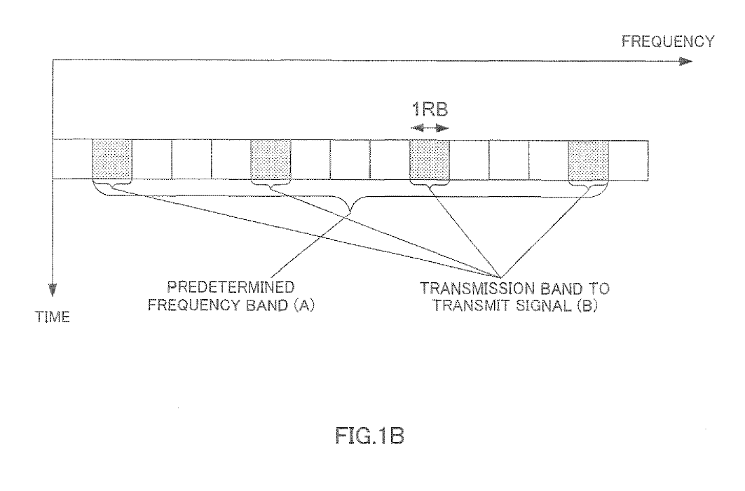

A configuration of base station 100 according to the present embodiment will be explained with reference to FIG. 2.

Coding section 101 in base station 100 shown in FIG. 2 receives, as input, transmission data (downlink data), a response signal (ACK signal or NACK signal) inputted from error detecting section 116, grant indicating resource allocation information at the time of the first transmission or retransmission grant indicating resource allocation information at the time of retransmission, which are inputted from scheduling section 118. Here, control information is formed by a response signal, and grant or retransmission grant. Then, coding section 101 encodes transmission data and control information, and outputs encoded data to modulation section 102.

Modulation section 102 modulates the encoded data inputted from coding section 101, and outputs a modulated signal to transmission RF section 103.

Transmission RF section 103 applies transmission processing, including D/A conversion, up-conversion, amplification and so forth, to the signal inputted from modulation section 102, and transmits a signal to which transmission processing has been applied, from antenna 104 to each terminal by radio.

Reception RF section 105 applies reception processing, including down-conversion, A/D conversion and so forth, to a signal received from each terminal via antenna 104, and outputs a signal to which reception processing has been applied, to demultiplexing section 106.

Demultiplexing section 106 demultiplexes the signal inputted from reception RF section 105 into a reference signal and a data signal. Then, demultiplexing section 106 outputs the reference signal to DFT (discrete Fourier transform) section 107 and outputs the data signal to DFT section 110.

DFT section 107 applies DFT processing to the reference signal inputted from demultiplexing section 106, and transforms a time domain signal to a frequency domain signal. Then, DFT section 107 outputs the reference signal transformed into a frequency domain signal, to demapping section 108.

Demapping section 108 extracts reference signals matching transmission bands for respective terminals, from the reference signal in the frequency domain inputted from DFT section 107. Then, demapping section 108 each extracted reference signal to estimating section 109.

Estimating section 109 estimates an estimation value of frequency variations (channel frequency responses) on the propagation path and an estimation value of reception quality, based on the reference signal inputted from demapping section 108. Then, estimating section 109 outputs the estimation value of channel frequency variations to frequency domain equalizing section 112, and outputs the estimation value of reception quality to scheduling section 118.

Meanwhile, DFT section 110 applies DFT processing to the data signal inputted from demultiplexing section 106 and transforms a time domain signal to a frequency domain signal. Then, DFT section 110 outputs the data signal transformed into a frequency domain signal, to demapping section 111.

Demapping section 111 extracts data signals matching transmission bands for respective terminals, from the signal inputted from DFT section 110. Then, demapping section 111 outputs each extracted signal to frequency domain equalizing section 112.

Frequency domain equalizing section 112 applies equalization processing to the data signal inputted from demapping section 111 using the estimation value of frequency variations (channel frequency responses) on the propagation path inputted from estimating section 109. Then, frequency domain equalizing section 112 outputs a signal to which equalization processing has been applied, to IFFT (inverse fast Fourier transform) section 113.

IFFT section 113 applies LEFT processing to the data signal inputted from frequency domain equalizing section 112. Then, IFFT section 113 outputs a signal to which IFFT processing has been applied, to demodulation section 114.

Demodulation section 114 applies demodulation processing to the signal inputted from IFFT section 113, and outputs a signal to which demodulation processing has been applied, to decoding section 115.

Decoding section 115 applies decoding processing to the signal inputted from demodulation section 114, and outputs a signal (decoded bit sequence) to which decoding processing has been applied, to error detecting section 116.

Error detecting section 116 performs error detection on the decoded bit sequence inputted from decoding section 115. For example, error detecting section 116 performs error detection using CRC check. When there is an error in decoded bits as a result of error detection, error detecting section 116 generates a NACK signals as a response signal, and, on the other hand, when there is no error in decoded bits, generates an ACK signal as a response signal. Then, error detecting section 116 outputs a generated response signal to coding section 101 and determination section 117. In addition, when there is no error in decoded bits, error detecting section 116 outputs a data signal as received data.

Determination section 117 and scheduling section 118 receive, as input, HARQ selection information indicating which HARQ is used between the first HARQ and the second HARQ.

When the response signal inputted from error detecting section 116 is a MACK signal and HARQ indicated by HARQ selection information is the first HARQ (that is, at the time of retransmission using the first HARQ), determination section 117 determines a bandwidth from one end to the other end of the transmission band allocated to transmission signals (transmission data and reference signals) at the time these transmission signals are retransmitted, that is, the bandwidth of a predetermined frequency band, based on scheduling information (grant or retransmission grant) at the time of last transmission inputted from scheduling section 118. To be more specific, determination section 117 first calculates the degree of continuity of signals transmitted from a terminal last time, using grant at the time of last transmission, which is inputted from scheduling section 118. Here, assume that the proportion of the band to transmit signals to a predetermined frequency band is the degree of continuity of signals transmitted from a terminal in the frequency domain.

Then, determination section 117 determines the bandwidth of a predetermined frequency band at the time of retransmission, according to the degree of continuity at the time of last transmission. To be more specific, when the proportion of the band to transmit signals to a predetermined frequency band at the time of last transmission is lower (when the degree of continuity is lower), determination section 117 increases the amount of decrease in the bandwidth of a predetermined frequency band at the time of retransmission, with respect to the time of last transmission. That is, when the degree of continuity is lower at the time of last transmission, determining section 117 increases the proportion of the band to transmit data to a predetermined frequency band, that is, the amount of increase in the degree of continuity. Then, determination section 117 outputs information indicating the determined bandwidth to scheduling section 118.

Scheduling section 118 schedules bands (frequency resources) to transmit signals from respective terminals, based on HARQ selection information, the estimation value of reception quality inputted from estimating section 109 and information indicating the bandwidth inputted from determination section 117. For example, at the time of the first transmission, scheduling section 118 schedules a band to transmit signals transmitted at the first time, based on the estimation value of reception quality, and outputs grant representing the result of scheduling to coding section 101 and determination section 117.

In addition, when HARQ indicated by HARQ selection information is the second HARQ, scheduling section 118 schedules a band to transmit signals (retransmission signals) from a retransmitting terminal, based on the estimation value of reception quality, and outputs retransmission grant representing the result of scheduling to coding section 101 and determination section 117. Moreover, scheduling section 118 allocates signals transmitted from terminals other than the retransmitting terminal, to frequency bands including the transmission band scheduled to be used by the retransmitting terminal at the time of retransmission.

On the other hand, when HARQ indicated by HARQ selection information is the first HARQ, scheduling section 118 secures a transmission band allocated to signals (retransmission signals) transmitted from a retransmitting terminal, based on the bandwidth indicated by information inputted from determination section 117, and allocates signals transmitted from terminals other than the retransmitting terminal, to transmission bands other than the transmission band secured for the retransmitting terminal.

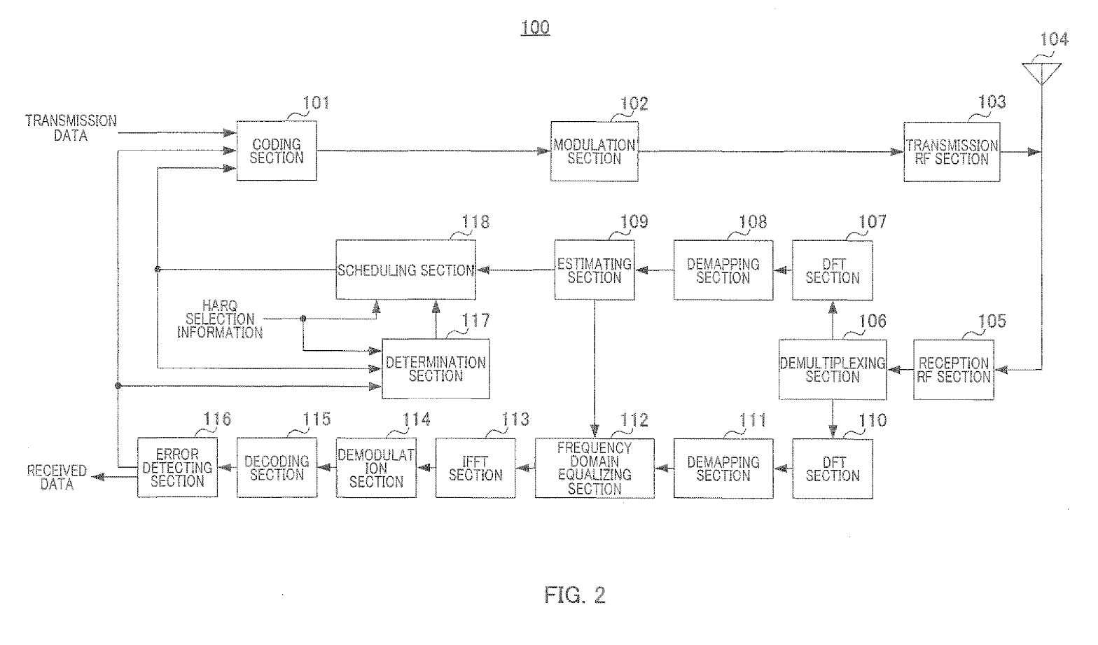

Next, a configuration of terminal 200 according to the present embodiment will be explained with reference to FIG. 3.

Reception RF section 202 in terminal 200 shown in FIG. 3 applies reception processing, including down-conversion, A/D conversion and so forth, to a signal received from base station 100 via antenna 201, and outputs a signal to which reception processing has been applied, to demodulation section 203.

Demodulation section 203 applies equalization processing and demodulation processing to the signal inputted from reception RF section 202, and outputs a signal to which equalization processing and demodulation processing have been applied, to decoding section 204.

Decoding section 204 applies decoding processing to the signal inputted from demodulation section 203 and extracts received data and control information. Decoding section 204 outputs the extracted control information to determination section 205. Here, control information includes a response signal (ACK signal or NACK signal), and grant or retransmission grant.

When control information inputted from decoding section 204 includes only a NACK signal, determination section 205 calculates the proportion of the band to transmit signals (transmission data and reference signals) at the time of last transmission to a predetermined frequency band, that is, the degree of continuity of signals transmitted from terminal 200 last time in the frequency domain. Then, determination section 205 determines the bandwidth from one end to the other end of the transmission band allocated to transmission signals at the time of retransmission (that is, the bandwidth of a predetermined frequency band). Here, when the proportion of the band to transmit signals in a predetermined frequency band is lower (when the degree of continuity is lower), determination section 205 increases the amount of decrease in the bandwidth of a predetermined frequency band at the time of retransmission, with respect to the time of last transmission, like determination section 117 (FIG. 2). Then, determination section 205 outputs information indicating the determined bandwidth to allocating section 209. Here, processing to determine the bandwidth of a predetermined frequency band in determination section 205 will be described in detail later.

CRC section 206 performs CRC coding on transmission data to generate CRC coded data, and outputs the generated CRC coded data to coding section 207.

Coding section 207 encodes the CRC coded data inputted from CRC section 206, and outputs encoded data to modulation section 208.

Modulation section 208 modulates the encoded data inputted from coding section 207, and outputs a modulated data signal to allocating section 209.

Allocating section 209 allocates the data signal (the first transmission signal or retransmission signal) inputted from modulation section 208, to a frequency resource (RB), based on grant or retransmission grant inputted from decoding section 204, or information indicating the bandwidth inputted from determination section 205. Allocating section 209 outputs the signal allocated to the RB to multiplexing section 210.

Multiplexing section 210 time multiplexes a reference signal and the signal inputted from allocating section 209, and outputs a multiplexed signal to transmission RF section 211.

Transmission RF section 211 applies transmission processing, including D/A conversion, up-conversion, amplification and so forth, to the multiplexed signal inputted from multiplexing section 210, and transmits a signal to which transmission processing has been applied, from antenna 201 to base station 100 by radio.

Next, processing to determine the bandwidth of a predetermined frequency band at the time of retransmission in determination section 205 (FIG. 3) in terminal 200 according to the present embodiment, will be described in detail.

in the following descriptions, for example, as shown in FIG. 1A, when signals are transmitted from terminal 200 by localized transmission, predetermined frequency band (A) having a bandwidth from one end to the other end of the transmission band to which signals transmitted from terminal 200 are allocated, is composed of four RBs, and band (B) to transmit these signals is also composed of four RBs. Therefore, proportion B/A (the degree of continuity) of band (B) to transmit signals to predetermined frequency band (A) is 1 (=4/4). That is, the degree of continuity (proportion B/A) at the time of localized transmission is the maximum value 1. On the other hand, when signals are transmitted from terminal 200 by distributed transmission, predetermined frequency band (A) is composed of thirteen RBs and band (B) to transmit these signals is composed of four RBs. Therefore, proportion B/A (the degree of continuity) of band (B) to transmit signals to predetermined frequency band (A) is 4/13. That is, the degree of continuity (proportion B/A) at the time of distributed transmission is lower than 1.

Moreover, in the following descriptions, a case will be explained where terminal 200 has not detected retransmission grant from base station 100. Here, as the case in which terminal 200 has not detected retransmission grant from base station 100, there are a case in which although the second HARQ is applied to signals transmitted from terminal 200 and base station 100 transmits retransmission grant to terminal 200, terminal 200 cannot detect the retransmission grant, and a case in which the first HARQ is applied to signals transmitted from terminal 200.

When proportion B/A is lower (the degree of continuity is lower), determination section 205 increases the amount of decrease in the bandwidth of predetermined frequency band (A) at the time of retransmission, with respect to the time of last transmission. For example, as shown in FIG. 1A, when the degree of continuity (proportion B/A) is 1(=4/4), determination section 205 determines the amount of decrease in the bandwidth of predetermined frequency band (A) at the time of retransmission with respect to the time of last transmission, to be zero RB. By this means, predetermined frequency band (A) at the time of retransmission is composed of four (=4−0) RBs, which is the same as at the time of last transmission. That is, the degree of continuity (proportion B/A) of transmission signals in the frequency domain is the same as at the time of last transmission, which is one (=4/4) RB at the time of retransmission. By contrast with this, as shown in FIG. 1B when the degree of continuity (proportion B/A) at the time of last transmission is 4/13, determination section 205 determines the amount of decrease in the bandwidth of predetermined frequency band (A) at the time of retransmission, with respect to the time of last transmission, to be four RBs, which is greater than in a case in which the degree of continuity is 1 (the amount of decrease=zero RB). By this means, predetermined frequency band (A) at the time of retransmission is composed of nine (=13−4) RBs. That is, the degree of continuity (proportion B/A) of transmission signals in the frequency domain is 4/9 at the time of retransmission.

As described above, when terminal 200 does not receive retransmission grant directed to terminal 200, terminal 200 narrows predetermined frequency band (A) at the time of retransmission, as compared to the bandwidth of predetermined frequency band (A) at the time of last transmission. Here, when the degree of continuity at the time of last transmission is lower (the degree of continuity is 4/13 in FIG. 1B), terminal 200 increases the amount of decrease in the bandwidth of a predetermined frequency band at the time of retransmission, with respect to the time of last transmission (the amount of decrease is four RBs in FIG. 1B), and, on the other hand, when the degree of continuity at the time of last transmission is higher (the degree of continuity is the maximum value 1 in FIG. 1A), decreases the amount of decrease in the bandwidth of the predetermined frequency band at the time of retransmission, with respect to the time of last transmission (the amount of decrease is the minimum value of zero RB in FIG. 1A).

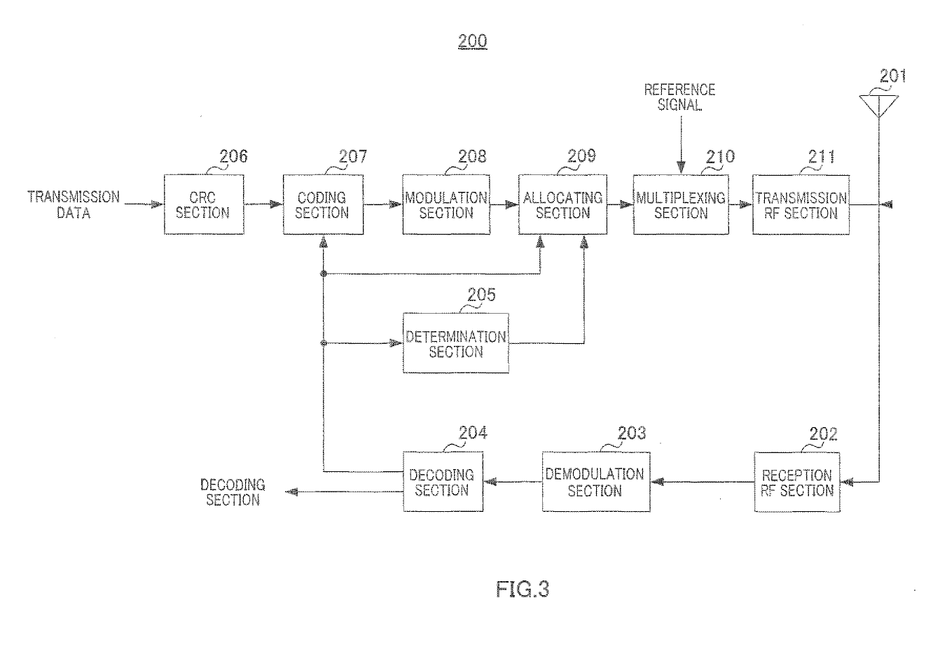

Here, base station 100 transmits retransmission grant to terminal 200, and for example, as shown in FIG. 4, allocates frequency bands including the transmission band allocated to terminal 200 at the time of last transmission (at the time of the first transmission), to other terminals (terminal A and terminal B). In FIG. 4, transmission signals from terminal A and terminal B are transmitted by localized transmission at the time of retransmission (at the time of the second transmission) from terminal 200. However, when terminal 200 cannot retransmission grant directed to terminal 200 although base station 100 transmits the retransmission grant, terminals 200 allocate retransmission signals to the transmission band allocated to terminal 200 at the time of last transmission (at the time of first transmission). Here, terminal 200 narrows the bandwidth of predetermined frequency band (A) to transmit signals (retransmission signals) at the time of retransmission, as compared to the bandwidth at the time of last transmission (the time of the first transmission) as shown in FIG. 4. By this means, as shown in FIG. 4, retransmission signals from terminal 200 are redundantly allocated to only the transmission band to allocate terminal A. For example, when retransmission signals from terminal 200 are allocated to the same transmission band as at the time of last transmission, these retransmission signals interfere with both terminal A and terminal B. However, according to the present embodiment, as shown in FIG. 4, retransmission signals from terminal 200 interfere with only terminal A but do not interfere with terminal B.

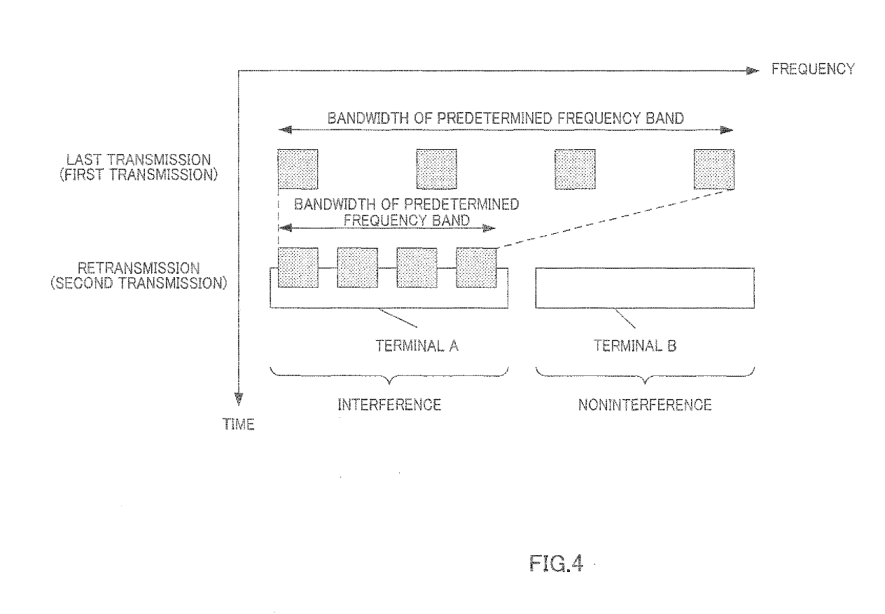

Next, FIG. 5 shows a specific example of sequences according to the present embodiment. With reference to FIG. 5, a case will be explained where although the second HARQ is applied to signals transmitted from terminal 200 and base station 100 transmits retransmission grant to terminal 200, terminal 200 cannot detect the retransmission grant.

In step (hereinafter “ST”) 101, scheduling section 118 in base station 100 schedules transmission bands (frequency resources) allocated to signals (data signals) transmitted from terminal 200, based on the estimation value of reception quality (that is, the reception quality fed back from terminal 200). In ST 102, base station 100 transmits grant indicating the result of scheduling to terminal 200.

In ST 103, allocating section 209 in terminal 200 allocates data signals to RBs based on the grant from base station 100. In ST 104, terminal 200 transmits the data signals allocated to the RBs, to base station 100.

In ST 105, error detecting section 116 in base station 100 performs error detection on the data signals transmitted from terminal 200, and generates a response signal (ACK signal or NACK signal). Here, error detecting section 116 generates a NACK signal as a response signal. In addition, scheduling section 118 in base station 100 generates retransmission grant indicating the transmission band to allocate retransmission signals from terminal 200 to. Moreover, base station 100 allocates the transmission band indicated by the grant generated in ST 101, to other terminals (for example, terminal A and terminal B shown in FIG. 4). In ST 106, base station 100 transmits control information including the generated response signal (NACK signal) and retransmission grant, to terminal 200. Here, assume that terminal 200 cannot detect retransmission grant directed to terminal 200 because of influence by, for example, low channel quality of the downlink at this time.

Therefore, terminal 200 receives only a NACK signal from base station 100 as control information and determines that the first HARQ is applied to data signals from terminal 200, so that, in ST 107, determination section 205 calculates the degree of continuity of transmission signals at the time of last transmission in the frequency domain, based on the transmission band indicated by the grant received by ST 102, that is, the transmission band at the time of last transmission. Then, determination section 205 determines the bandwidth of a predetermined frequency band to transmit signals at the time of retransmission, according to the degree of continuity.

In ST 108, allocating section 209 in terminal 200 allocates retransmission signals to RBs, based on the bandwidth determined in ST 107, and retransmits the signals to base station 100.

Here, if the first HARQ is applied to signals transmitted from terminal 200, determination section 117 in base station 100 increases the amount of decrease in the bandwidth of a predetermined frequency band at the time of retransmission, with respect to the time of last transmission, when the degree of continuity at the time of last transmission is lower, like determination section 205. At this time, base station 100 can allocate the transmission band corresponding to the amount of decrease in the bandwidth of a predetermined frequency band, to other terminals. To be more specific, when there is an error in signals transmitted from terminal 200 at the time of last transmission (the time of the first transmission), base station 100 transmits only a NACK signal to terminal 200. Here, as shown in FIG. 4, base station 100 and terminal 200 narrow the bandwidth of a predetermined frequency band to transmit signals (retransmission signals) at the time of retransmission (for example, the time of the second transmission), as compared to the bandwidth at the time of last transmission. By this means, at the time transmission signals from terminal 200 are retransmitted (at the time of the second transmission), the transmission band (equivalent to the bandwidth for terminal B shown in FIG. 4) corresponding to the amount of decrease in the bandwidth of a predetermined frequency band, with respect to the time of last transmission (the time of the first transmission), is secured. Therefore, while securing the band to transmit signals from terminal 200, base station 100 can schedule a newly secured transmission band for another terminal (for example, a terminal using localized transmission as terminal B shown in FIG. 4).

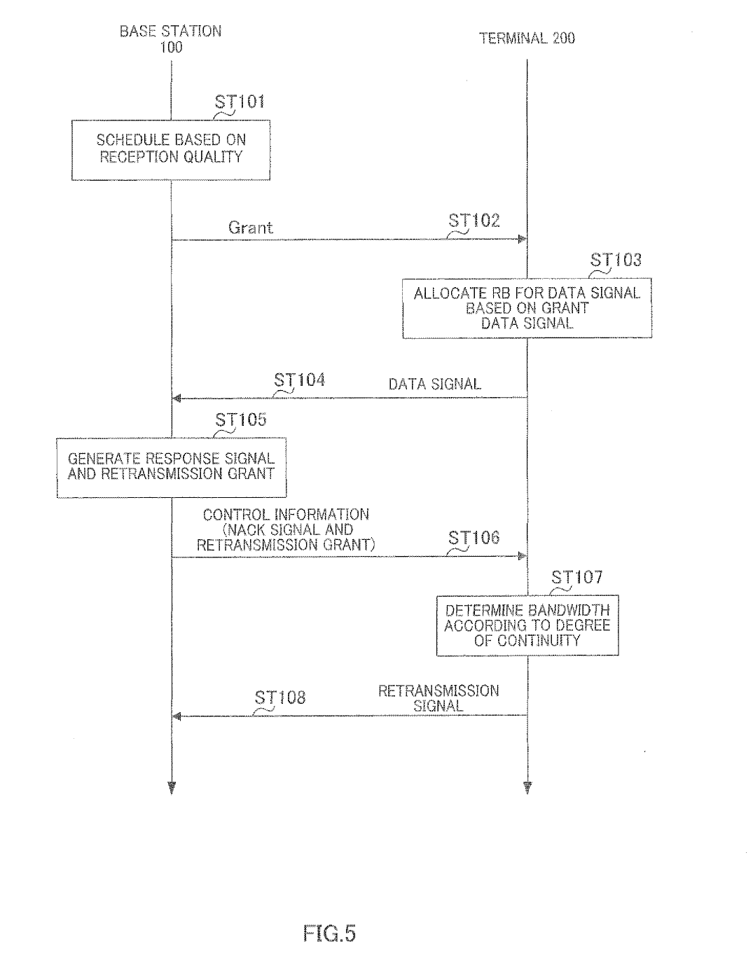

Next, examples 1-1 to 1-4 of determining the bandwidth of a predetermined frequency band to transmit signals in determination section 117 and determination section 205. FIG. 6 to FIG. 9 show associations between the degree of continuity at the time of last transmission and the degree of continuity at the time of retransmission. In FIG. 6 to FIG. 9, the degree of continuity at the time of last transmission is x (0<x≦1), and the degree of continuity at the time of retransmission is y (0<y≦1). Here, when the degree of continuity at the time of last transmission is x=1, the degree of continuity at the time of retransmission is y=1. In addition, in FIG. 6 to FIG. 9, a case in which degree of continuity x at the time of last transmission is the same as degree of continuity y at the time of retransmission, that is, y=x, is indicated by broken lines.

### Determination Example 1-1

### FIG. 6

With this determination example, when the degree of continuity of signals transmitted last time is lower in the frequency domain, the amount of decrease in the bandwidth of a predetermined frequency band at the time of retransmission is increases with respect to the time of last transmission.

That is, when the degree of continuity at the time of last transmission is lower, determination section 107 and determination section 205 increases the amount of decrease in the bandwidth of predetermined frequency band (A), which is the denominator of proportion B/A, at the time of retransmission. Here, transmission band (B) of proportion B/A does not vary between the time of last transmission and the time of retransmission. Therefore, when the degree of continuity at the time of last transmission is lower, the amount of decrease in the bandwidth of predetermined frequency band (A) increases, so that the amount of increase in the degree of continuity (proportion B/A) at the time of retransmission increases. To be more specific, as shown in FIG. 6, the relationship of y=αx+S (here, α<1 and s is any number) holds between degree of continuity x at the time of last transmission and degree of continuity y at the time of retransmission. Here, in FIG. 6, S=1−α.

As shown in FIG. 6, when degree of continuity x at the time of last transmission is lower, the amount of increase in degree of continuity y at the time of retransmission (that is the difference between the solid line and the broken line on the y axis at the same vale on the x axis. In addition, as shown in FIG. 6, when the value of α decreases, the value of S(=1−α) increases, and the amount of increase in degree of continuity y at the time of retransmission increases with respect to degree of continuity x at the time of last transmission.

As described above, according to this determination example, when the degree of continuity at the time of last transmission is lower, terminal 200 increases the amount of decrease in the bandwidth of a predetermined frequency band at the time of retransmission, with respect to the time of last transmission. By this means, when terminal 200 has not detected retransmission grant transmitted from base station 100, retransmission signals transmitted from terminal 200 are allocated to a predetermined frequency band having a narrower bandwidth than that at the time of last transmission. Therefore, even if terminal 200 cannot detect retransmission grant and allocates retransmission signals incorrectly, to the transmission band to which signals transmitted from other terminals are allocated, the retransmission signals from terminal 200 collide and interfere with signals transmitted from part of other terminals, but does not interfere with terminals other than the part. In other words, according to this determination example, it is possible to reduce the number of other terminals to be interfered with from retransmission signals from terminal 200 by focusing the transmission band to allocate the retransmission signals to, on part of the frequency band. Therefore, it is possible to decrease the number of other terminals whose reception quality deteriorates due to collisions with retransmission signals from terminal 200.

### Determination Example 1-2

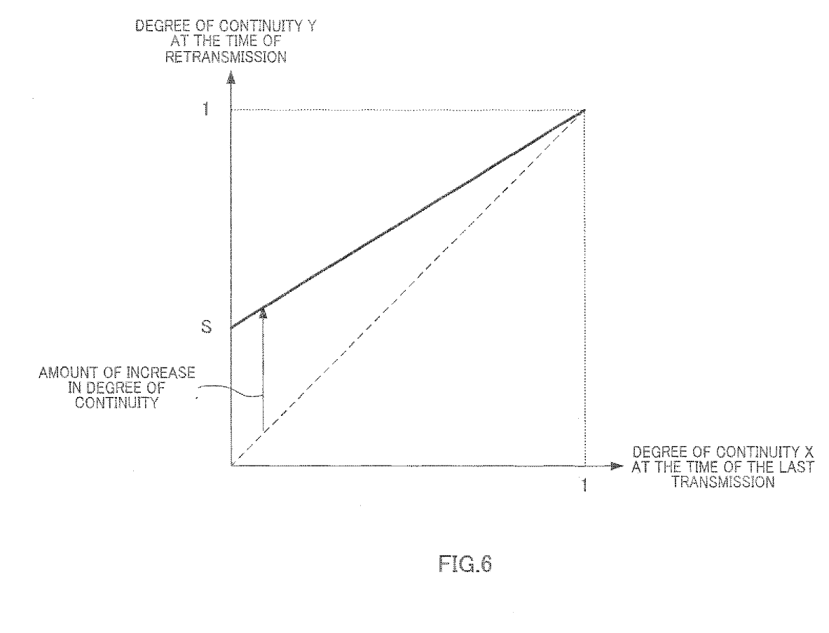

### FIG. 7

With this determination example, when the degree of continuity of signals transmitted last time is lower in the frequency domain, the amount of decrease in the bandwidth at the time of retransmission increases with respect to the time of last transmission, so that the bandwidth of a predetermined frequency band in which the degree of continuity is 1 at the time of retransmission, is determined.

To be more specific, when the degree of continuity at the time of last transmission is lower, determination section 117 and determination section 205 increases the amount of decrease in the bandwidth of predetermined frequency band (A) at the time of retransmission, with respect to the time of last transmission. Here, whatever the degree of continuity at the time of the last time transmission is, determination section 117 and determination section 205 determine the bandwidth in which the degree of continuity (proportion B/A) at the time of retransmission is 1. In other words, whatever the degree of continuity at the time of the last time transmission determination section 117 and determination section 205 determine the bandwidth of predetermined frequency band (A) at the time of retransmission to transmit signals at the time of retransmission by localized transmission.

To be more specific, as shown in FIG. 7, the relationship of y=b (here, b=1) holds between degree of continuity x at the time of last transmission and degree of continuity y at the time of retransmission. That is, whatever degree of continuity x at the time of last transmission is, degree of continuity y at the time of retransmission is 1. Here, the relationship in this determination example shown in FIG. 7 is equivalent to the relationship of y=αx+S (here, α=1−S) between degree of continuity x at the time of last transmission and degree of continuity y at the time of retransmission in determination example 1-1 (FIG. 6) if S=1.

As described above, at the time of retransmission, determination section 117 and determination section 205 minimize the bandwidth of predetermined frequency band (A) to transmit signals (retransmission signals) by localized transmission. For example, even if transmission signals were distributed and allocated over all the frequency bands (the degree of continuity: 4/13) at the time of last transmission as shown in FIG. 1B, transmission signals are allocated to consecutive transmission bands (the degree of continuity: 1(=4/4) at the time of retransmission as shown in FIG. 1A.

Therefore, even if terminal 200 cannot detect retransmission grant transmitted from base station 100 and erroneously allocates retransmission signals to transmission band to which signals transmitted from other terminals are allocated, it is possible to reduce the number of other terminals to be interfered with from retransmission signals from terminal 200, like in determination example 1-1. In addition, base station 100 can secure more consecutive transmission bands, for example, in transmission bands other than the transmission band to allocate retransmission signals to (that is, the transmission band in which interference occurs), as shown in FIG. 1A. Therefore, base station 100 can allocate signals transmitted from other terminals (for example, terminals using localized transmission) to consecutive transmission bands other than the transmission band to allocate retransmission signals from terminal 200 to.

As described above, according to this determination example, it is possible to reduce the number of other terminals to be interfered with from terminal 200 at the time of retransmission. Moreover, according to this determination example, transmission signals from terminal 200 are allocated to consecutive transmission bands at the time of retransmission, so that base station 100 can secure consecutive transmission bands for other terminals. This allows base station 100 to flexibly schedule transmission bands for other terminals.

### Determination Example 1-3

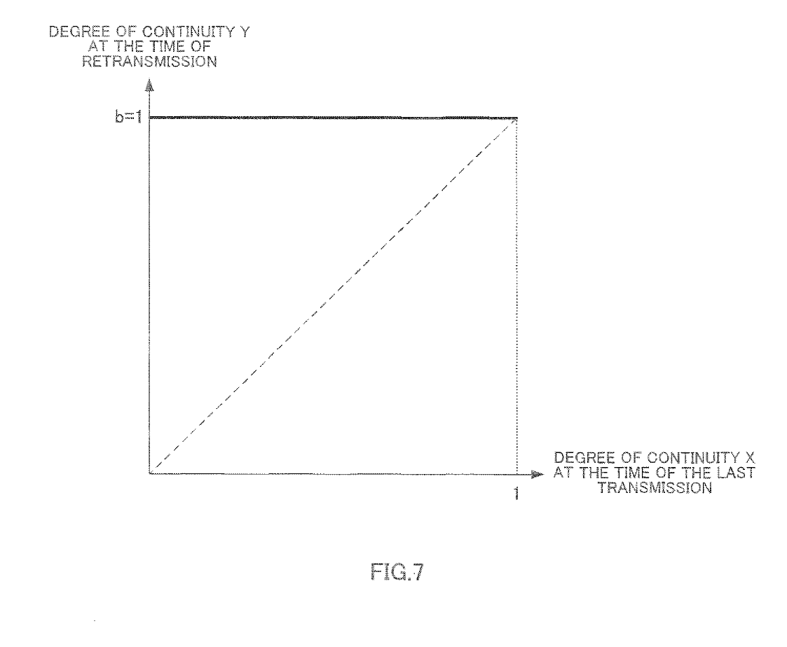

### FIGS. 8A and 8B

Assume that the bandwidth of a predetermined frequency band to transmit signals from terminal 200 last time is, for example, equal to or smaller than the bandwidth of the transmission band to allocate transmission signals from terminal A shown in FIG. A. In this case, as the above-described determination examples 1-1 and 1-2, even if base station 100 and terminal 200 do not narrow the bandwidth of a predetermined frequency band to transmit signals from terminal 200, transmission signals from terminal 200 interfere with transmission signals from only terminal A, but do not interfere with transmission signals from terminal B.

That is, even if the bandwidth of a predetermined frequency band is not narrowed at the time of retransmission, depending on the degree of continuity at the time of last transmission, it is possible to reduce the number of terminals to be interfered with from transmission signals from terminal 200.

Therefore, with this determination example, only if the degree of continuity of transmission signals in the frequency domain is lower than a predetermined threshold, when the degree of continuity of these transmission signals is lower, the amount of decrease in the bandwidth of a predetermined frequency band at the time of retransmission, with respect to the time of last transmission.

To be more specific, determination section 117 and determination section 205 set in advance a predetermined threshold to determine whether or not to narrow the bandwidth of a predetermined frequency band at the time of retransmission. Then, if the degree of continuity at the time of last transmission is lower than the predetermined threshold, determination section 117 and determination section 205 increase the amount of decrease in the bandwidth of a predetermined frequency band when the degree of continuity at the time of last transmission is lower, like in determination example 1-1 (or determination example 1-2). Meanwhile, when the degree of continuity at the time of last transmission is equal to or higher than the predetermined threshold, determination section 117 and determination section 205 determine the amount of decrease in the bandwidth of a predetermined frequency band to be 0. That is, when the degree of continuity at the time of last transmission is equal to or higher than the predetermined threshold, determination section 117 and the determination section 205 determine the degree of continuity at the time of retransmission to be the same as the degree of continuity at the time of last transmission.

For example, as shown in FIG. 8A, when degree of continuity x at the time of last transmission is lower than threshold T, the relationship of y=αx+(T(1−α)) (here α<1) holds between degree of continuity x at the time of last transmission and degree of continuity y at the time of retransmission. Meanwhile, when degree of continuity x at the time of last transmission is equal to or higher than threshold T, the relationship of y=x holds between degree of continuity x at the time of last transmission and degree of continuity y at the time of retransmission. This is equivalent to the relationship of y=αx+(T(1−α)) if α=1. That is, when degree of continuity x at the time of last transmission is equal to or higher than threshold T, degree of continuity y at the time of retransmission is the same as degree of continuity x at the time of last transmission by making slope α of degree of continuity y1, and, on the other hand, when degree of continuity x at the time of last transmission is lower than threshold T, degree of continuity y at the time of retransmission is higher than degree of continuity x at the time of last transmission by making slope a of degree of continuity y smaller than 1.

Here, threshold T is set to the degree of continuity to allow the bandwidth to transmit signals from terminal A shown in FIG. 4. In this case, when the degree of continuity of transmission signals from terminal 200 is equal to or higher than threshold T, even if degree of continuity y at the time of retransmission is the same as degree of continuity x at the time of last transmission, transmission signals from terminal 200 interfere with only transmission signals from terminal A, but do not interfere with transmission signals from terminal B. Here, the setting value of threshold T is not limited to the above-described setting value.

As described above, when degree of continuity x at the time of last transmission is high (equal to or higher than threshold T), even if terminal 200 does not narrow the bandwidth of a predetermined frequency band, it is possible to reduce the number of other terminals to be interfered with from transmission signals from terminal 200 at the time of retransmission. On the other hand, when degree of continuity x at the time of last transmission is low (lower than threshold T), terminal 200 increase the amount of decrease in the bandwidth of a predetermined frequency band at the time of retransmission, with respect to the time of last transmission when degree of continuity x is tower, so that it is possible to reduce the number of terminals to be interfered with from transmission signals from terminal 200 at the time of retransmission, like determination example 1-1.

As described above, according to this determination example, when the degree of continuity at the time of last transmission is lower than threshold T, it is possible to produce the same effect as in determination example 1-1. In addition, according to this determination example, when the degree of continuity at the time of last transmission is equal to or higher than threshold T, the degree of continuity at the time of retransmission is the same as the degree of continuity at the time of last transmission, so that it is possible to produce the same frequency diversity effect as that at the time of last transmission while reducing the number of other terminals to be interfered with from transmission signals from terminal 200.

Here, with this determination example, association shown in FIG. 8B may be used as association between degree of continuity x at the time of last transmission and degree of continuity y at the time of retransmission, instead of the association shown in FIG. 8A. In FIG. 8B, when degree of continuity x at the time of last transmission is equal to or higher than threshold T, the association is the same as in FIG. 8A, and, on the other hand, when degree of continuity x at the time of last transmission is lower than threshold T, the relationship of y=T holds between degree of continuity x at the time of last transmission and degree of continuity y at the time of retransmission.

### Determination Example 1-4

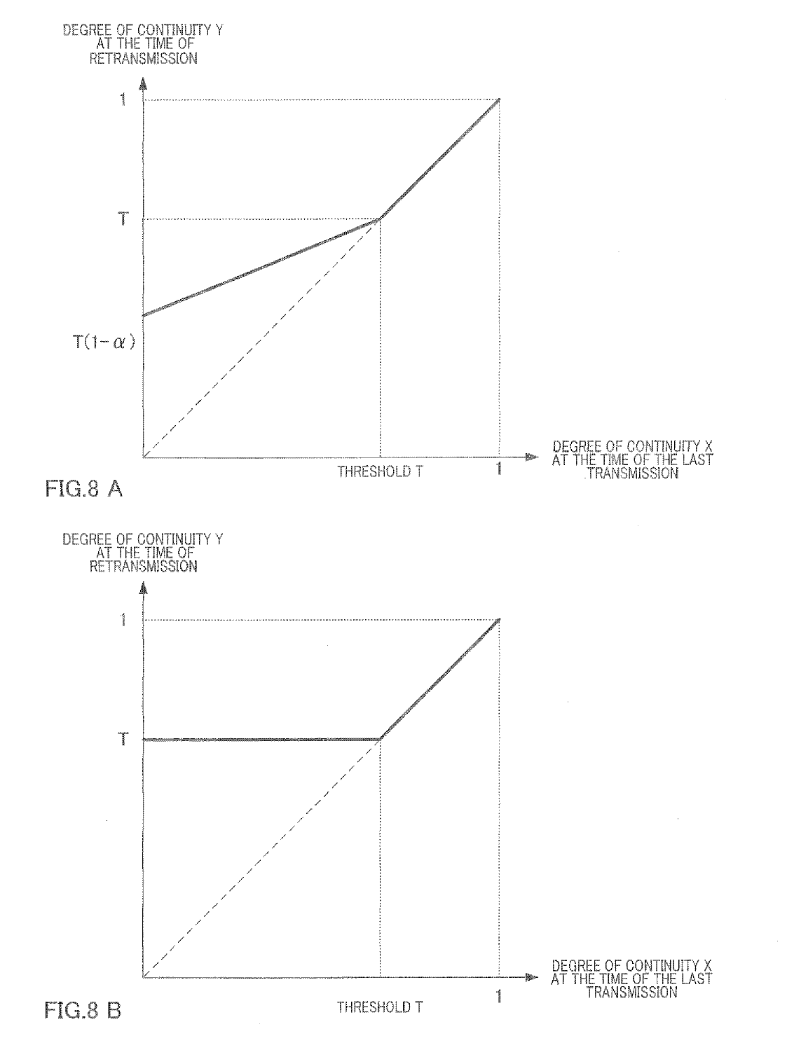

### FIG. 9

When the degree of continuity of transmission signals is lower in the frequency domain, the bandwidth of a predetermined frequency band is wider. Therefore, when the degree of continuity at the time of last transmission is lower, it is necessary to increase the amount of decrease in the bandwidth of a predetermined frequency band at the time of retransmission, in order to reduce the number of other terminals to be interfered with from retransmission signals from terminal 200 when terminal 200 cannot detect retransmission grant. On the other hand, when the degree of continuity at the time of last transmission is higher, an effect of reducing the number of other terminals to be interfered with from retransmission signals from terminal 200 by narrowing the bandwidth of a predetermined frequency band at the time of retransmission with respect to the time of last transmission, is lower.

Therefore, with this determination example, the proportion of the amount of decrease in the bandwidth of predetermined frequency band (A) at the time of retransmission varies between a case in which the degree of continuity at the time of last transmission is lower than threshold T and the degree of continuity at the time of last transmission is equal to or higher than threshold T. To be more specific, a proportion of the amount of decrease in the bandwidth of a predetermined frequency band at the time of retransmission when the degree of continuity at the time of last transmission is lower than threshold T is higher than when the degree of continuity at the time of last transmission is equal to or higher than threshold T.

For example, as shown in FIG. 9, when degree of continuity x at the time of last transmission is lower than threshold T, the relationship of y=βx+S′ (here, β<α, and S′ is any number) holds between degree of continuity x at the time of the last time transmission and degree of continuity y at the time of retransmission. On the other hand, as shown in FIG. 9, when degree of continuity x at the time of last transmission is equal to or higher than threshold T, the relation ship of y=α(x−T)+(βT+S′) (here, β<α, and S′ is any number) holds between degree of continuity x at the time of the last time transmission and degree of continuity y at the time of retransmission (here α<1 and S′ is any number).

When degree of continuity x at the time of last transmission is lower than threshold T, the slope of degree of continuity y at the time of retransmission is β, and, when degree of continuity x at the time of last transmission is lower than threshold T, the slope of degree of continuity y at the time of retransmission is u at the larger value than β. That is, the relationship of β<α<1 holds between slope α and slope β of degree of continuity y at the time of retransmission. Therefore, as shown in FIG. 9, the proportion of the amount of increase in the degree of continuity at the time of retransmission with respect to the time of last transmission (slope=1) when degree of continuity x at the time of last transmission is lower than threshold T (slope=β) is greater than when degree of continuity x at the time of last transmission is equal to or higher than threshold T (slope=α). In other words, the proportion of the amount of decrease in the bandwidth of a predetermined frequency band at the time of retransmission with respect to the time of last transmission (slope=1) when degree of continuity x at the time of last transmission is lower than threshold T (slope=β) is greater than when the degree of continuity x at the time of last transmission is equal to or higher than threshold T (slope=α).

As described above, according to this determination example, when degree of continuity x at the time of last transmission is lower (when degree of continuity x is lower than threshold T), that is, when a possibility to increase the number of other terminals to be interfered with from retransmission signals from terminal 200 that could not have detected retransmission grant transmitted from base station 100, is higher, it is possible to increase the proportion of the amount of decrease in the bandwidth of a predetermined frequency band at the time of retransmission.

Therefore, according to this determination example, it is possible to finely determine the bandwidth of a predetermined frequency band at the time of retransmission more than in determination example 1-1, according to the degree of continuity at the time of last transmission.

Examples 1-1 to 1-4 for determining the frequency band of a predetermined frequency band to transmit signals in determination section 117 and determination section 205 have been explained.

As described above, according to the present embodiment, when the degree of continuity of signals transmitted last time is lower in the frequency domain, terminal 200 increases the amount of decrease in the frequency band of a predetermined frequency band at the time of retransmission, with respect to the time of last transmission. By this means, even if the degree of continuity at the time of last transmission is low, it is possible to transmit signals in a narrow band at the time of retransmission, so that it is possible to reduce the number of other terminals whose reception quality of transmission signals deteriorates due to interference of transmission signals (retransmission signals) from terminal 200. Therefore, according to the present embodiment, even if a terminal fails to receive correctly retransmission grant from a base station, it is possible to reduce the number of other terminal to be interfered with from the terminal at the time of retransmission.

Here, with the present embodiment, a case has been explained where, although base station 100 transmits retransmission grant, terminal 200 cannot detect the retransmission grant. However, the present invention is applicable to a case where, although a base station transmits an ACK signal as a response signal, terminal detects the ACK signal as a NACK signal by mistake. To be more specific, base station 100 transmits an ACK signal to terminal 200 and allocates the transmission band for retransmission scheduled to be used by terminal 200, to transmission signals from other terminals. Meanwhile, terminal 200 receives the ACK signal as a NACK signal by mistake, and therefore allocates transmission signals to the transmission band for retransmission and retransmits the transmission signals. Here, like the present embodiment, terminal 200 determines the bandwidth of a predetermined frequency band to transmit signals at the time of retransmission, according to the degree of continuity at the time of last transmission, it is possible to reduce a possibility of occurrence of collisions between transmission signals from other terminals newly allocated by base station 100 and retransmission signals from terminal 200 In this way, according to the present embodiment, even if a terminal detects an ACK signal from a base station as a NACK signal by mistake, it is possible to reduce the number of other terminals to be interfered with from the terminal at the time of retransmission.

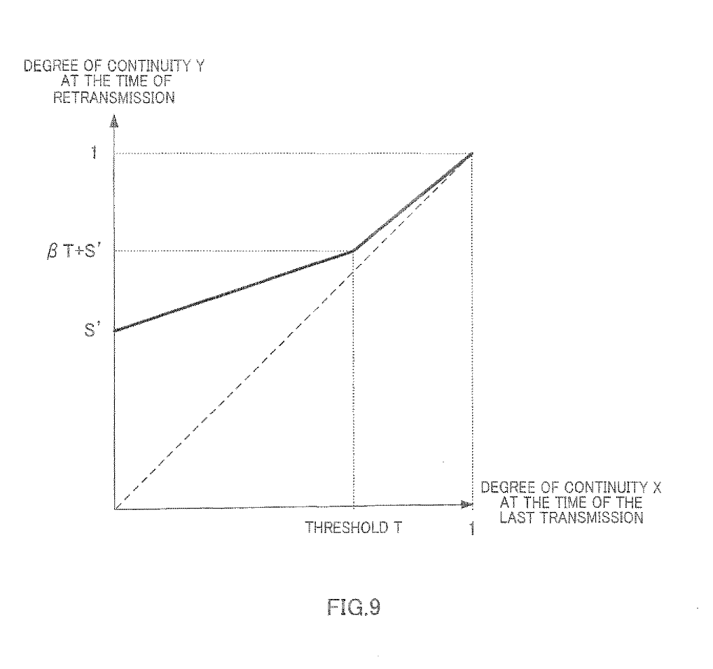

In addition, with the present embodiment, a case has been explained where, degree of continuity y at the time of retransmission is retained before and after threshold T when threshold T is set, for example, as shown in determination example 1-3 (FIG. 8A and FIG. 8B) and determination example 1-4 (FIG. 9). However, with the present invention, for example, as shown in FIG. 10, degree of continuity y at the time of retransmission may not retained before and after threshold T. In FIG. 10, when degree of continuity x at the time of last transmission is lower than threshold T, the relationship of y=βx+S″ (here β<α, and S″ is any number) holds between degree of continuity x at the time of last transmission and degree of continuity y at the time of retransmission. On the other hand, when degree of continuity x at the time of last transmission is equal to or higher than threshold T, the relationship of y=α(x−T)+R holds between degree of continuity x at the time of last transmission and degree of continuity y at the time of retransmission (here α<1 and R is any number). That is, degree of continuity y at the time of retransmission varies with the difference of βT before and after threshold T as shown in FIG. 10.

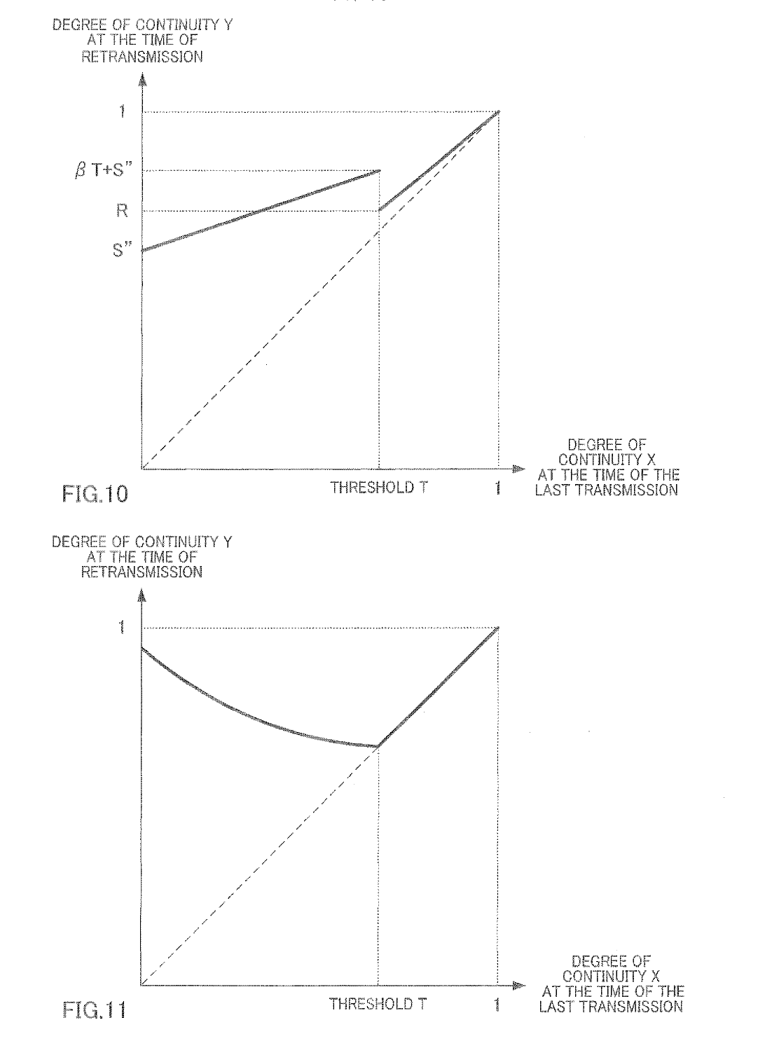

Moreover, with the present embodiment, a case has been explained where degree of continuity x at the time of last transmission and degree of continuity y at the time of retransmission are represented by linear function, for example, as shown in FIG. 6 to FIG. 10. However, according to the present invention, it is preferable to satisfy the condition that the amount of decrease in the bandwidth of predetermined frequency band (A) at the time of retransmission increases with respect to the time of last transmission when degree of continuity x at the time of last transmission is lower. For example, the present invention is also applicable to a case in which degree of continuity at the time of last transmission and degree of continuity y at the time of retransmission are represented by quadratic function as shown in FIG. 11.

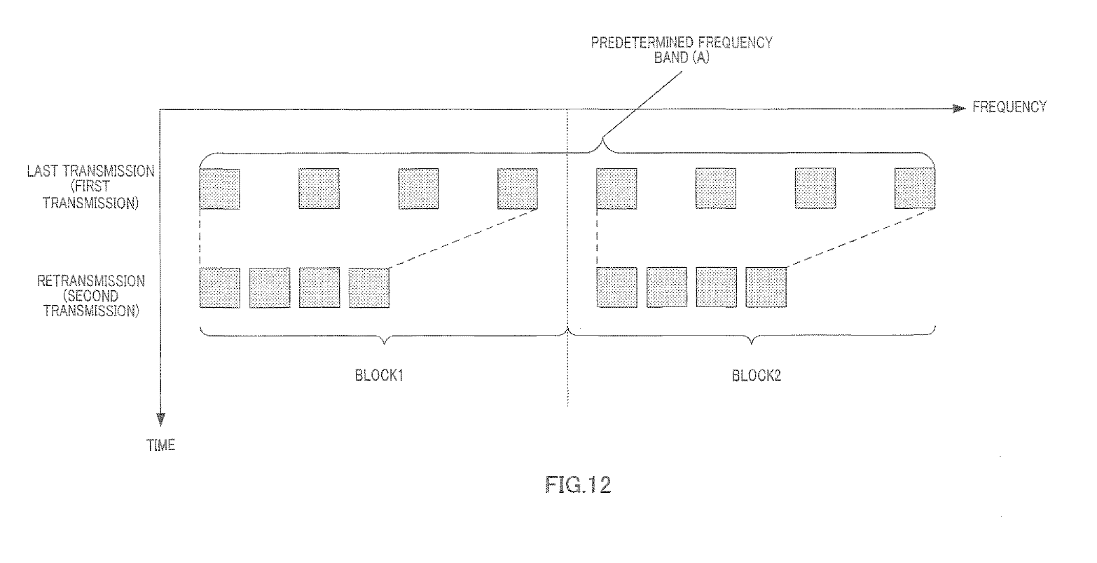

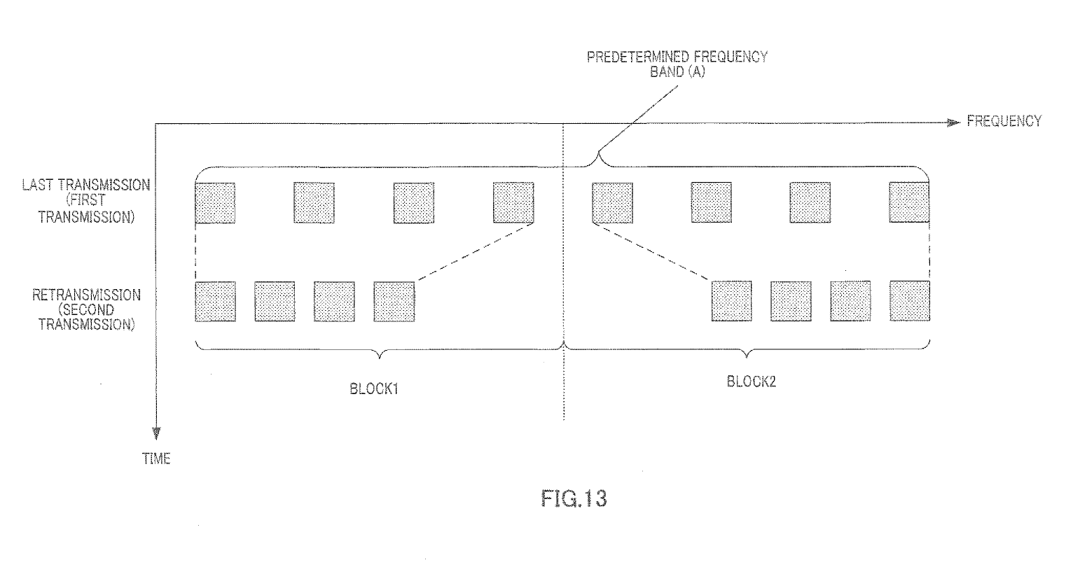

Moreover, with the present embodiment, a case has been explained where the present invention is applied to the entire predetermined frequency band to transmit signals, as shown in FIG. 4. However, the present invention may be applied to, for example, part of predetermined frequency band (A) to transmit signals shown in FIG. 12 and FIG. 13. To be more specific, as shown in FIG. 12 and FIG. 13, predetermined frequency band (A) to transmit signals is divided into block 1 and block 2, and the present invention may be partly applied to block 1 and block 2 on a per block basis.

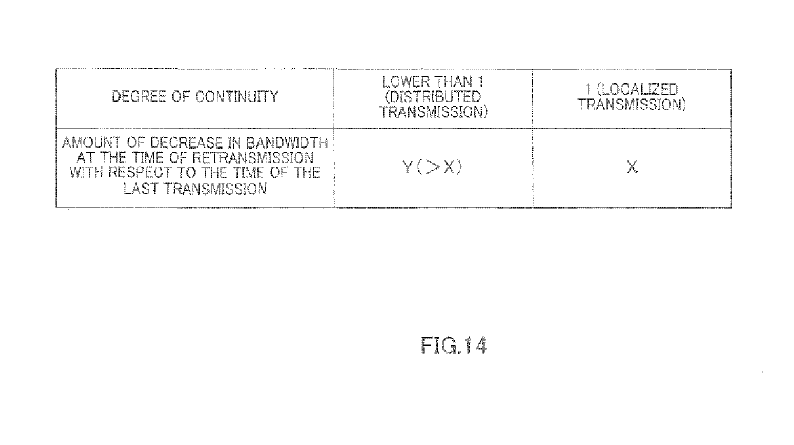

Moreover, with the present embodiment, a case has been explained where the bandwidth of a predetermined frequency band at the time of retransmission is determined, according to the degree of continuity at the time of last transmission. For example, according to the present invention, the degree of continuity at the time of last transmission may be set to two values (the degree of continuity 1 (localized transmission)) and the degree of continuity lower than 1 (distributed transmission). For example, as shown in FIG. 14, when the degree of continuity is the maximum value 1 (localized transmission), determination section 117 and determination section 205 determine the amount of decrease in the bandwidth of a predetermined frequency band at the time of retransmission, with respect to the time of last transmission, to be X. On the other hand, when the degree of continuity is lower than 1 (distributed transmission), determination section 117 and determination section 205 determine the amount of decrease in the bandwidth of a predetermined frequency band at the time of retransmission, with respect to the time of last transmission, to be Y greater than the amount of decrease X which is the value when the degree of continuity is 1.

### Embodiment 2

With Embodiment 1, a case has been explained where the proportion of band to transmit signals in a predetermined frequency bands is the degree of continuity of transmission signals in the frequency domain. By contrast with this, with the present embodiment, a case will be explained where the frequency interval between neighboring bands to transmit signals in the frequency domain is the degree of continuity of transmission signals in the frequency domain.

For example, as shown in FIG. 1A, when signals from terminal 200 are transmitted by localized transmission, transmission bands to allocate transmission signals from terminal 200 continue, so that the frequency interval between neighboring transmission bands is the minimum value 0. On the other hand, as shown in FIG. 1B, signals from terminal 200 are transmitted by distributed transmission, the frequency interval between neighboring transmission bands, among transmission bands to allocate transmission signals from terminal 200, is three RBs. That is, with the present embodiment, the degree of continuity of transmission signals in the frequency domain is maximized when the frequency interval between neighboring transmission bands is minimized as the time of localized transmission. In addition, when the frequency interval between neighboring transmission bands is greater, the degree of continuity of transmission signals is lower in the frequency domain.

Therefore, determination section 117 (FIG. 2) in base station 100 and determination section 205 (FIG. 3) in terminal 200 according to the present embodiment determine the bandwidth of a predetermined frequency band at the time of retransmission with respect to the time of last transmission, according to the frequency interval between neighboring transmission bands, among transmission bands to allocate transmission signals from terminal 200. Here, when the frequency interval between neighboring bands to transmit signals transmitted last time is higher (that is, when the degree of continuity is lower), determination section 117 and determination section 205 increase the amount of decrease in the bandwidth of a predetermined frequency band at the time of retransmission with respect to the time of last transmission.

Now, detailed descriptions will be explained. Like Embodiment 1, here, a case in which terminal 200 does not detect retransmission grant transmitted from 100, and a case in which the first HARQ is applied to transmission signals from terminal 200, will be explained.

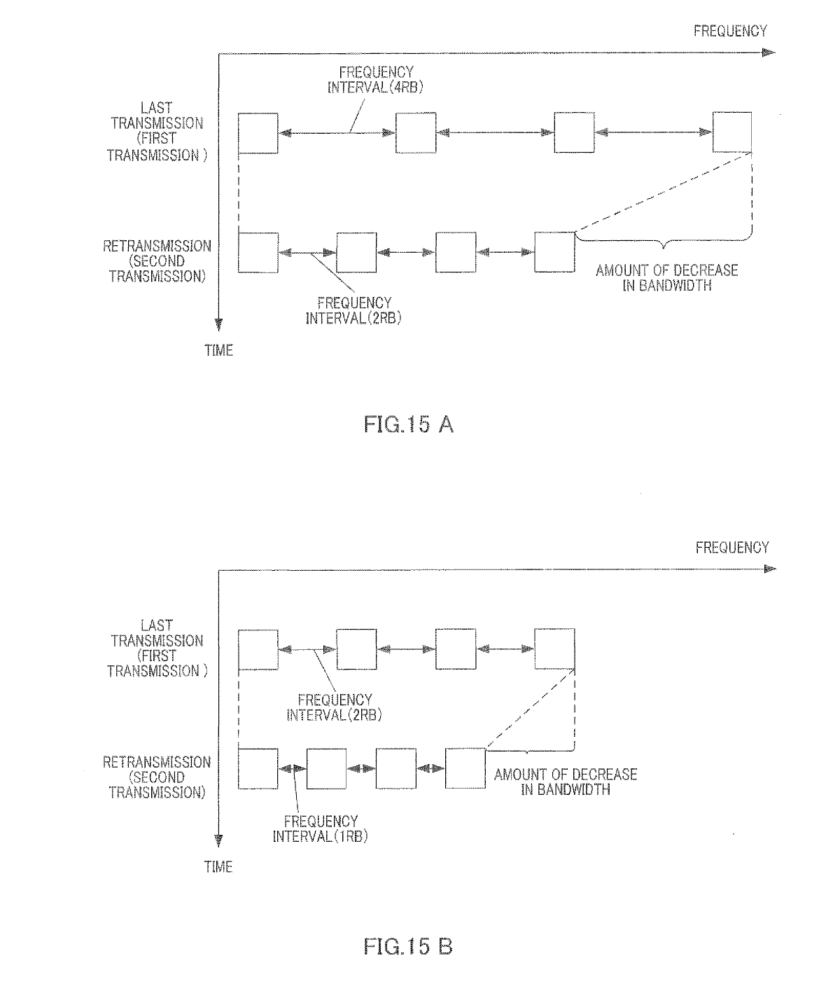

For example, as shown in FIG. 15A, when the frequency interval between neighboring transmission bands at the time of last transmission (the time of the first transmission) is four RBs, determination section 117 and determination section 205 determine the frequency interval between neighboring transmission bands at the time of retransmission (the time of the second transmission) to be two RBs. That is, determination section 117 and determination section 205 determine that the amount of decrease in the frequency interval between neighboring transmission bands at the time of retransmission with respect to the time of last transmission to be two RBs.

In addition, as shown in FIG. 15B, when the frequency interval between neighboring transmission bands at the time of last transmission (at the time of the first transmission) is two RBs, determination section 117 and determination section 205 determine the frequency interval between neighboring transmission bands at the time of retransmission (at the time of the second transmission) to be one RB. That is, determination section 117 and determination section 205 determine the amount of decrease in the frequency interval between neighboring transmission bands at the time of retransmission with respect to the time of the first transmission, to be one RB.

As described above, determination section 117 and determination section 205 increase the amount of decrease in the frequency interval between neighboring transmission bands at the time of retransmission with respect to the time of last transmission when the frequency interval between neighboring transmission bands is four RBs (FIG. 15) at the time of last transmission more than when the frequency interval between neighboring transmission bands is two RBs (FIG. 15B). By this means, over the entire predetermined frequency band to transmit signals, as shown in FIG. 15A and FIG. 15B, when the frequency interval between neighboring bands to transmit signals at the time of last transmission is greater, the amount of decrease in the bandwidth of a predetermined frequency band at the time of retransmission increases with respect to the time of last transmission, like in Embodiment 1. That is, the amount of decrease in the bandwidth of a predetermined frequency band at the time of retransmission, with respect to the time of last transmission in FIG. 15A (the frequency interval is four RBs at the time of last transmission) is greater than the amount of decrease in the bandwidth of a predetermined frequency band at the time of retransmission, with respect to the time of last transmission in FIG. 15B (the frequency interval is two RBs at the time of last transmission).

When the frequency interval between neighboring transmission bands is greater at the time of last transmission (e.g. FIG. 15A), the amount of decrease in the bandwidth of a predetermined frequency band increases at the time of retransmission. By this means, even if terminal 200 cannot detect retransmission grant, it is possible to reduce the number of other terminals to be interfered with from transmission signals from terminal 200 at the time of retransmission. In addition, when the frequency interval between neighboring transmission bands is smaller at the time of last transmission (e.g. FIG. 15B), the amount of decrease in the bandwidth of a predetermined frequency band at the time of retransmission to reduce the number of other terminals to be interfered with from retransmission signals from terminal 200, may be smaller. Therefore, when the frequency interval between neighboring transmission bands is smaller at the time of last transmission, it is possible to reduce the number of other terminals to be interfered with from transmission signals from terminal 200 at the time of retransmission while preventing deterioration of the frequency diversity effect of transmission signals from terminal 200.

With the present embodiment, in this way, the bandwidth of a predetermined frequency band at the time of retransmission is determined according to the frequency interval between neighboring transmission bands in the frequency domain. By this means, like in Embodiment 1, even if a terminal fails to receive correctly retransmission grant from a base station, it is possible to reduce the number of other terminals to be interfered with from the terminal at the time of retransmission.

### Embodiment 3

With the present embodiment, a case will be explained where, when the number of divisions of the transmission band to transmit signals last time is greater, the amount of decrease in the number of divided bands at the time of retransmission increases with respect to the time of last transmission.

When HARQ indicated by HARQ selection information is the first HARQ, and a response signal inputted from error detection section 116 is a NACK signal, determination section 117 (FIG. 2) in base station 100 according to the present embodiment determines the number of divided bands to transmit signals at the time of retransmission, according to the number of divided bands to transmit signals from terminal 200 last time. Here, when the number of divided bands at the time of last transmission is greater, determination section 117 increases the number of decrease in the number of divided bands at the time of retransmission.

Meanwhile, when control information from decoding section 204 does not include retransmission grant, determination section 205 (FIG. 3) in terminal 200 according to the present embodiment determines the number of divided bands to transmit signals at the time of retransmission, according to the number of divided bands at the time of last transmission, like determination section 117. Here, when the number of divided bands at the time of last transmission is greater, determination section 205 increases the number of decrease in the number of divided bands at the time of retransmission.

Now, detailed descriptions will be explained. Like Embodiment 1, here, a cases in which terminal 200 does not detect retransmission grant transmitted from base station 100 and a case in which the first HARQ is applied to transmission signals from terminal 200, will be explained.

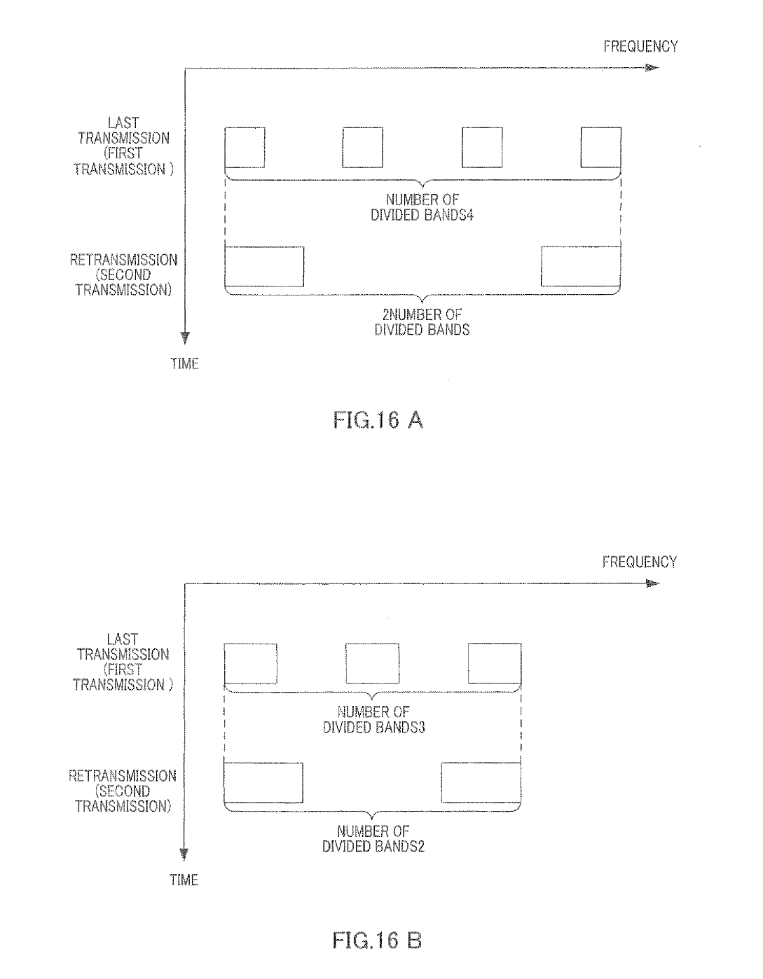

For example, as shown in FIG. 16A, when the number of divided bands to transmit signals at the time of last transmission (the time of the first transmission is 4, determination section 117 and determination section 205 determine the number of divided bands at the time of retransmission (the time of the second transmission) to be 2. That is, determination section 117 and determination section 205 determine the amount of decrease in the number of divided bands at the time of retransmission to be 2, with respect to the time of last transmission.

In addition, for example, as shown in FIG. 16B, when the number of divided bands to transmit signals at the time of last transmission (the time of the first transmission) is 3, determination section 117 and determination section 205 determine the number of divided bands at the time of retransmission (the time of the second transmission) to be 2. That is, determination section 117 and determination section 205 determine the amount of decrease in the number of divided bands at the time of retransmission is 1, with respect to the time of last transmission.

As described above, determination section 117 and determination section 205 increases the number of decrease in the divided bands at the time of retransmission with respect to the time of last transmission when the number of divided bands at the time of last transmission is 4 (FIG. 16A) more than when the number of divided bands is 3 (FIG. 16B).

As shown in FIG. 16A and FIG. 16B, at the time of last transmission, transmission signals are allocated to transmission bands distributed over a predetermined frequency band. In addition, as shown in FIG. 16, when the number of divided bands is greater, bands to transmit signals are finely distributed over a predetermined frequency band. To be more specific, when the number of divided bands is greater, it is difficult to secure consecutive transmission bands in a predetermined frequency band, as transmission bands other than the transmission band to allocate transmission signals from terminal 200. By contrast with this, as shown in FIG. 16A and FIG. 16B, at the time of retransmission, transmission signals are collectively allocated to both ends of a frequency band to transmit signals. By this means, it is possible to secure consecutive transmission bands (near the center of a predetermined frequency band in FIG. 16A and FIG. 16B) as transmission bands other than the transmission band to allocate transmission signals from terminal 200 to).

By this means, even if terminal 200 cannot detect retransmission grant even if terminal 200 transmits the retransmission grant, consecutive transmission bands are secured as transmission bands other than the band to transmit retransmission signals from terminal 200, so that it is possible to reduce the number of terminals to be interfered with from retransmission signals from terminal 200, like in Embodiment 1. In addition, when the first HARQ is applied to terminal 200, base station 100 can allocate other terminals (for example, terminals using localized transmission) to consecutive transmission bands other than the transmission band to which transmission signals from terminal 200 are allocated.

In this way, with the present embodiment, the number of divided bands at the time of retransmission is determined, according to the number of divided bands to transmit signals transmitted last time. By this means, even if a terminal fails to receive correctly retransmission grant from a base station, it is possible to reduce the number of other terminals to be interfered with from the terminal at the time of retransmission.

### Embodiment 4

With the present embodiment, a case will be explained where, when the bandwidth of a predetermined frequency band to transmit signals transmitted last time is wider, the rate of decrease in the bandwidth of a predetermined frequency band at the time of retransmission increases with respect to the time of last transmission.

When HARQ indicated by HARQ selection information is the first HARQ, and a response signal inputted from error detection section 116 is a NACK signal, determination section 117 (FIG. 2) in base station 100 according to the present embodiment determines the bandwidth of a predetermined frequency band to transmit signals at the time of retransmission, according to the bandwidth of a predetermined frequency band to transmit signals from terminal 200 last time. Here, when the bandwidth of a predetermined frequency band at the time of last transmission is wider, determination section 117 increases the rate of decrease in the bandwidth of a predetermined frequency band at the time of retransmission.

Meanwhile, when control information from decoding section 204 does not include transmission grant, determination section 205 (FIG. 3) in terminal 200 according to the present embodiment determines the bandwidth of a predetermined frequency band to transmit signals at the time of retransmission, according to the bandwidth of a predetermined frequency band to transmit signals last time, like determination section 117. Here, when the bandwidth of a predetermined frequency band at the time of last transmission is wider, determination section 205 increases the rate of decrease in the bandwidth of a predetermined frequency band at the time of retransmission.

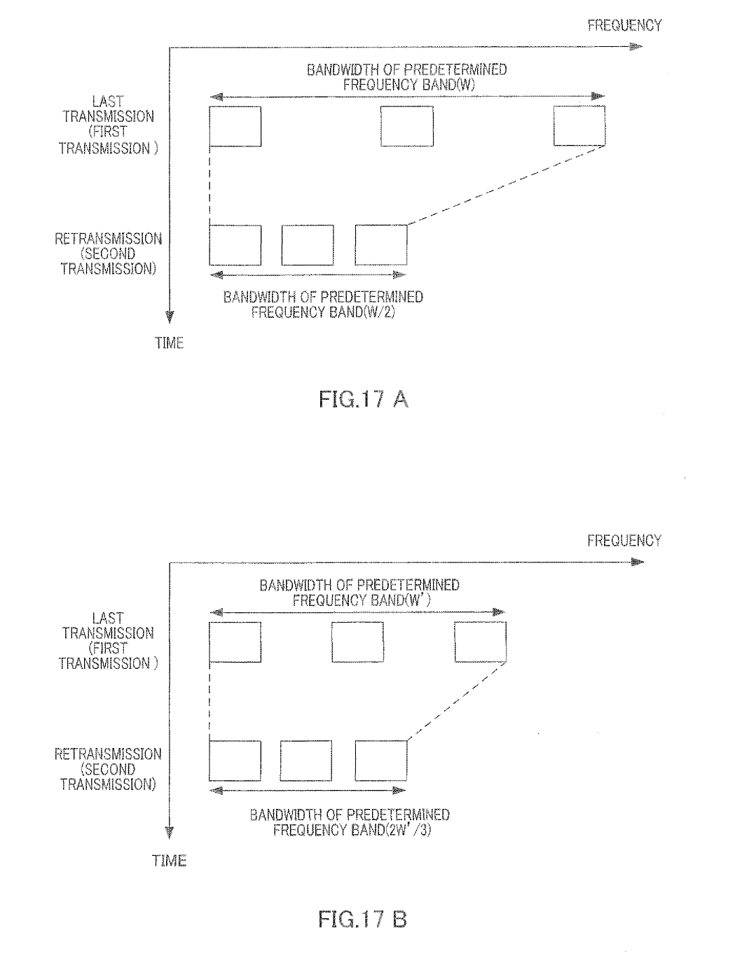

Now, detailed descriptions will be explained. Like in Embodiment 1, here, a case in which terminal 200 does not detect retransmission grant from base station 100 and a case in which the first HARQ is applied to transmission signals from terminal 200, will be explained. In addition, in FIG. 17A and FIG. 17B, bandwidth W of a predetermined frequency band is wider than bandwidth W′ of a predetermined frequency band (that is, bandwidth W>bandwidth W′).

For example, as shown in FIG. 17A, when the bandwidth of a predetermined frequency band to transmit signals at the time of last transmission (the time of the first transmission), determination section 117 and determination section 205 determine the bandwidth of a predetermined frequency band at the time of retransmission (the time of the second transmission) to be bandwidth (W/2) that is 1/2 of the bandwidth at the time of last transmission. That is, determination section 117 and determination section 205 determine the rate of decrease in the bandwidth of a predetermined frequency band at the time of retransmission, with respect to the time of last transmission, to be 1/2.

Meanwhile, as shown in FIG. 17B, when the bandwidth of a predetermined frequency band to transmit signals at the time of last transmission (the time of the first transmission) is W′, determination section 117 and determination section 205 determine the bandwidth of a predetermined frequency band at the time of retransmission (the time of the second transmission) to be (2W′/3) that is 2/3 of the bandwidth at the time of last transmission. That is, determination section 117 and determination section 205 determine the rate of decrease in the bandwidth of a predetermined frequency band at the time of retransmission with respect to the time of last transmission to be 2/3.

As describe above, when the bandwidth of a predetermined frequency band at the time of last transmission is W(>bandwidth W′), determination section 117 and determination section 205 increases the rate of decrease in the bandwidth of a predetermined frequency band at the time of retransmission with respect to the time of last transmission more than when the bandwidth of a predetermined frequency band is W′.

When the bandwidth of a predetermined frequency band at the time of last transmission is wider (e.g. FIG. 17A), the rate of decrease in the bandwidth of a predetermined frequency band at the time of retransmission is higher. By this means, even if terminal 200 cannot detect retransmission grant, it is possible to reduce the number of other terminals to be interfered with from transmission signals from terminal 200 at the time of retransmission, like in Embodiment 1. In addition, when bandwidth (W′) of a predetermined frequency band is narrower at the time of last transmission (e.g. FIG. 17B), the rate of decrease in the bandwidth of a predetermined frequency band at the time of retransmission to reduce the number of other terminals to be interfered with from transmission signals from terminal 200, may be lower. When the bandwidth of a predetermined frequency band is narrower at the time of last transmission, it is possible to reduce the number of other terminals to be interfered with from transmission signals from terminal 200 at the time of retransmission while preventing deterioration of the frequency diversity effect on transmission signals from terminal 200.

In this way, with the present embodiment, the bandwidth of a predetermined frequency band at the time of retransmission is determined, according to the bandwidth of a predetermined frequency band to transmit signals last time. By this means, like in Embodiment 1, even if a terminal fails to receive correctly retransmission grant from a base station, it is possible to reduce the number of other terminals to be interfered with from the terminal at the time of retransmission.

Each embodiment of the present invention has been described.

Here, with the above-described embodiments, a case has been explained as an example where the present invention is applied to localized transmission and distributed transmission. However, the present invention may be applied to a transmission scheme using non-discrete transmission bands and a transmission scheme using discrete transmission band, not limited to localized transmission and distributed transmission. For example, SC-FDMA (Single Carrier-Frequency Division Multiplexing Access) transmission may be applied instead of localized transmission, and OFDMA (Orthogonal Frequency Division Multiplexing Access) transmission may be applied instead of distributed transmission.

Moreover, with the above-described embodiments, a case has been explained where the degree of continuity when a plurality of transmission bands all continue in the frequency domain is the maximum value 1, and the degree of continuity when at least one of a plurality of transmission bands discontinues is lower than 1. However, according to the present invention, for example, transmission bands may be replaced with subcarriers, and the degree of continuity when a plurality of subcarriers all continue may be the maximum value 1 and the degree of continuity when at least one of a plurality of sub carriers discontinues may be lower than 1. In addition, according to the present invention, the degree of continuity when a plurality of subcarriers are all placed at even intervals may be the maximum value 1, and the degree of continuity when at least one of a plurality of subcarriers is not placed at even intervals may be lower than 1.

Moreover, with the above-described embodiments, as the transmission band to allocate retransmission signals when a terminal cannot detect retransmission grant, a transmission band to which another robust terminal (for example, a terminal exhibiting high error correction performance) is allocated, may be used. By this means, in transmission bands other than the transmission band to which retransmission signals are allocated, other terminals can perform communication without interference of retransmission signals, and, in the transmission band to which retransmission signals are allocated, other robust terminals are interfered with from retransmission signals, but are highly likely to perform normal communication by error correction processing.

In addition, with the above-described embodiments, although a case has been explained as an example where data signals and reference signals are transmitted in the uplink from a base station to terminals, the present invention is applicable to transmission in the downlink from a base station to terminals likewise.

Moreover, with the above-described embodiments, although a case in which HARQ is used, has been explained, ARQ may be used in the present invention.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2008-227501, filed on Sep. 4, 2008, including the specification, drawings and abstract, is incorporated herein by reference in its entirety.

### INDUSTRIAL APPLICABILITY

The present invention is applicable to a mobile communication system and so forth.

1. A radio communication apparatus comprising:
a determination section that determines a bandwidth from an end to the other end of a transmission band to allocate transmission signal at a retransmission timing to retransmit the transmission signal; and
an allocating section that allocates the transmission signal to a frequency resource, based on the determined bandwidth,
wherein, when a degree of continuity of the transmission signal in a frequency domain at a previous transmission timing before the retransmission timing, is lower, the determination section increases an amount of decrease in the bandwidth at the retransmission timing, with respect to the previous transmission timing.

2. The radio communication apparatus according to claim 1, wherein the determination section uses a proportion of the transmission band in a frequency band having the bandwidth as the degree of continuity, and, when the proportion is lower, increases the amount of decrease.

3. The radio communication apparatus according to claim 1, wherein the determination section uses a frequency interval between neighboring transmission bands as the degree of continuity, and, when the frequency interval is greater, increases the amount of decrease.

4. The radio communication apparatus according to claim 1, wherein the determination section determines the bandwidth to make the degree of continuity at the retransmission timing 1 by increasing the amount of decrease when the degree of continuity is lower.

5. The radio communication apparatus according to claim 1, wherein the determination section determines the bandwidth to transmit the transmission signal by localized transmission at the retransmission timing, by increasing the amount of decrease when the degree of continuity is lower.

6. The radio communication apparatus according to claim 1, wherein, only when the degree of continuity is lower than a predetermined threshold, the determination section increases the amount of decrease when the degree of continuity is lower.

7. A bandwidth determination method of determining a bandwidth from an end to the other end of a transmission band to allocate transmission signal at a retransmission timing to retransmit the transmission signal, wherein, when a degree of continuity of the transmission signal in a frequency domain at a previous timing before the retransmission timing, is lower, an amount of decrease in the bandwidth at the retransmission timing increases with respect to the previous transmission timing.
